(19) United States
(12) Patent Application Publication
(10) Pub. No.: US 2022/0283294 A1
(43) Pub. Date: Sep. 8, 2022

(54) PHASE UNWRAPPING DEVICE AND PHASE UNWRAPPING METHOD

(71) Applicant: NEC Corporation, Minato-ku, Tokyo (JP)

(72) Inventors: Taichi TANAKA, Tokyo (JP); Osamu HOSHUYAMA, Tokyo (JP)

(73) Assignee: NEC Corporation, Minato-ku, Tokyo (JP)

(21) Appl. No.: 17/632,343

(22) PCT Filed: Aug. 5, 2019
(86) PCT No.: PCT/JP2019/030637

§ 371 Date: Feb. 2, 2022

(51) Int. Cl. G01S 13/90; G01B 9/02055; G06T 1/00

(52) U.S. Cl. CPC G01S 13/90; G01B 9/02075; G06T 1/0007

(57) ABSTRACT

The phase unwrapping device 10 includes coordinate transformation means 11 for transforming coordinates of a map including height information into SAR image coordinates, weight calculation means 12 for determining a place, from the map whose coordinates are transformed into the SAR image coordinate, where phase discontinuity may occur in a phase different image generated from two SAR images and attaching a weight to the place where it is determined that phase discontinuity may occur, and phase unwrapping means 13 for performing phase unwrapping for the phase difference image using the weight.

### TECHNICAL FIELD

The present invention relates to a phase unwrapping device and a phase unwrapping method for reconstructing an absolute phase value from a phase folded in the range of [−π, π].

### BACKGROUND ART

Synthetic Aperture Radar (SAR) technology is a technology that enables a flying object such as a satellite or an aircraft to transmit and receive electromagnetic waves while moving and obtain observation images equivalent to an antenna with a large aperture. Synthetic Aperture Radar is used, for example, to analyze elevation and surface displacement by processing reflected waves from the earth's surface. When SAR technology is used, the analyzer takes the time series of SAR images (SAR data) obtained by a synthetic aperture radar as input and performs time series analysis of the input SAR images.

Interferometric SAR analysis is an effective method for analyzing an elevation or a ground surface deformation. In the interferometric SAR analysis, the phase difference between radio signals of plural (for example, two) SAR images photographed at different times is calculated. Then, from the phase difference, a change in distance between the flying object and the ground that occurred during the shooting time period is detected.

The phase obtained by the interference is folded in the range of [−π, π]. Therefore, phase unwrapping is performed to return the phase to an absolute phase value, i.e., a phase value that is no longer folded and varies as a linear function of the distance between the flying object and the ground. One example of phase unwrapping is a method to integrate the phase difference between neighboring pixels in the interferometric SAR image (phase difference image). In practice, the phase differences between neighboring pixels are sequentially added along the integration path.

When the phase between neighboring pixels changes smoothly, there is a high possibility that phase unwrapping will be executed accurately, however, when the integral path passes through an area where the phase difference between neighboring pixels is large (for example, larger than π), accurate phase unwrapping may not be possible.

One method is to perform phase unwrapping by avoiding areas where the phase difference between neighboring pixels is large. FIGS. 8A and 8B are explanatory diagrams showing an example of a phase difference image.

FIG. 8A shows a phase difference image before phase unwrapping is executed. In FIG. 8A, Path 1 is an integration path that does not avoid areas with large phase differences. Path 2 is an integration path that avoids areas with large phase differences. FIG. 8B illustrates a phase difference image after phase unwrapping is executed for Path 2.

In order to detect an area where the phase difference is large, the boundary between the area with a large phase difference and the area without a large phase difference (discontinuous boundary) is detected. FIG. 9 is an explanatory diagram showing a method for detecting a boundary. As shown in FIG. 9, in order to detect a boundary, phase differences of four neighboring pixels are sequentially integrated (added). The point where the integrated value (added value) does not become 0 is regarded as an edge of the area where the phase difference is large. In the example shown in FIG. 9, the area where the integrated value is 2π and the area where the integrated value is −2π are the ends. The shortest path connecting the two ends is then considered to be the boundary.

The phase unwrapping method is also described in the non-patent literature 1.

### CITATION LIST

### Non-Patent Literature

NPL 1: M. Costantini, “A Novel Phase Unwrapping Method Based on Network Programming”, IEEE Transactions on Geoscience and Remote Sensing, Vol. 36, No. 3, PP. 813-821, May 1998. Sensing, Vol. 36, No. 3, PP. 813-821, May 1998

### SUMMARY OF INVENTION

### Technical Problem

However, when an object with a large phase difference such as a building is photographed (refer to (A) in FIG. 10), a phase discontinuous area occurs. When a method is used in which the shortest path connecting the ends is the boundary between the area with a large phase difference and the area without a large phase difference, the discontinuous boundary may not be correctly determined due to the phase discontinuous area existing between the ends (refer to (B) in FIG. 10). In the upper figure of (B) in FIG. 10, the U-shaped place indicates a place of the boundary (discontinuous boundary) between an area with a large phase difference and an area without a large phase difference. In the lower figure of (B) in FIG. 10, the white curve group indicates a place that was determined as a discontinuous boundary by the method that the shortest path connecting both ends is a discontinuous boundary. If the discontinuous boundary is not correctly determined, an unwrapping error occurs (refer to (C) in FIG. 10). The upper figure of (C) in FIG. 10 illustrates that the phase that is folded in the range of [−π, π] was stretched to the range of [0, 12π] by phase unwrapping. The lower figure of (C) in FIG. 10 illustrates that a phase folded in the range of [−π, π] was stretched only to the range of [0, 2π] by phase unwrapping. In other words, it is shown that an unwrapping error has occurred.

It is an object of the present invention to provide a phase unwrapping device and a phase unwrapping method capable of reducing occurrence of an unwrapping error.

### Solution to Problem

A phase unwrapping device according to the present invention includes coordinate transformation means for transforming coordinates of a map including height information into SAR image coordinates, weight calculation means for determining a place, from the map whose coordinates are transformed into the SAR image coordinate, where phase discontinuity may occur in a phase different image generated from two SAR images and attaching a weight to the place where it is determined that phase discontinuity may occur, and phase unwrapping means for performing phase unwrapping for the phase difference image using the weight.

A phase unwrapping method according to the present invention includes transforming coordinates of a map including height information into SAR image coordinates, determining a place, from the map whose coordinates are transformed into the SAR image coordinate, where phase discontinuity may occur in a phase different image generated from two SAR images and attaching a weight to the place where it is determined that phase discontinuity may occur, and performing phase unwrapping for the phase difference image using the weight.

A phase unwrapping program according to the present invention, causing a computer to execute a process of transforming coordinates of a map including height information into SAR image coordinates, a process of determining a place, from the map whose coordinates are transformed into the SAR image coordinate, where phase discontinuity may occur in a phase different image generated from two SAR images and attaching a weight to the place where it is determined that phase discontinuity may occur, and a process of performing phase unwrapping for the phase difference image using the weight.

### Advantageous Effects of Invention

According to the present invention, it is possible to reduce occurrence of an unwrapping error.

### BRIEF DESCRIPTION OF DRAWINGS

FIG. 1 It depicts a block diagram showing a configuration example of a phase unwrapping device of the first example embodiment.

FIG. 2 It depicts a flowchart showing an operation of a phase unwrapping device.

FIG. 3 It depicts an explanatory diagram showing operations of a coordinate transformation unit, a weight determination unit, and a discontinuous place calculation unit.

FIG. 4 It depicts a block diagram showing a configuration example of a phase unwrapping device of the second example embodiment.

FIG. 5 It depicts an explanatory diagram showing an application example of a phase unwrapping device.

FIG. 6 It depicts a block diagram showing an example of computer with a CPU.

FIG. 7 It depicts a block diagram showing the main part of a phase unwrapping device.

FIG. 8A It depicts an explanatory diagram showing an example of a phase difference image.

FIG. 8B It depicts an explanatory diagram showing an example of a phase difference image.

FIG. 9 It depicts an explanatory diagram to explain a method for detecting a boundary.

FIG. 10 It depicts an explanatory diagram to explain a phase discontinuous area.

### DESCRIPTION OF EMBODIMENTS

Hereinafter, example embodiments of the present invention are described with reference to the drawings.

### Example Embodiment 1

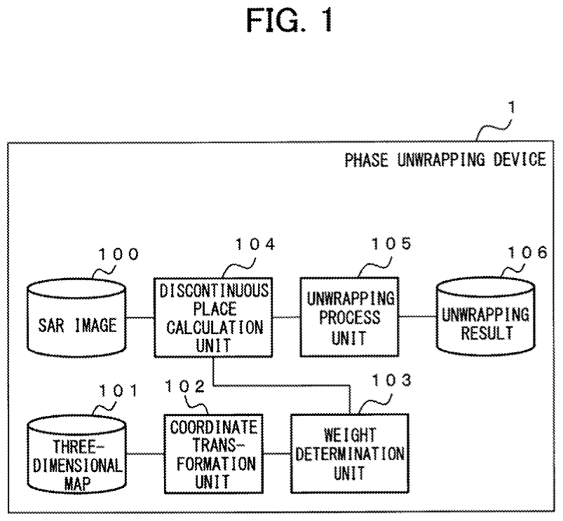

FIG. 1 is a block diagram showing a configuration example of a phase unwrapping device of the first example embodiment. The phase unwrapping device 1 shown in FIG. 1 includes a SAR image storage unit 100, a three-dimensional map storage unit 101, a coordinate transformation unit 102, a weight determination unit 103, a discontinuous place calculation unit 104, an unwrapping process unit 105, and an unwrapping result storage unit 106.

In the SAR image storage unit 100, a plurality of SAR images is stored. In the three-dimensional map storage unit 101, a three-dimensional map called DSM (Digital Surface Model), which includes height information of buildings and trees, is stored.

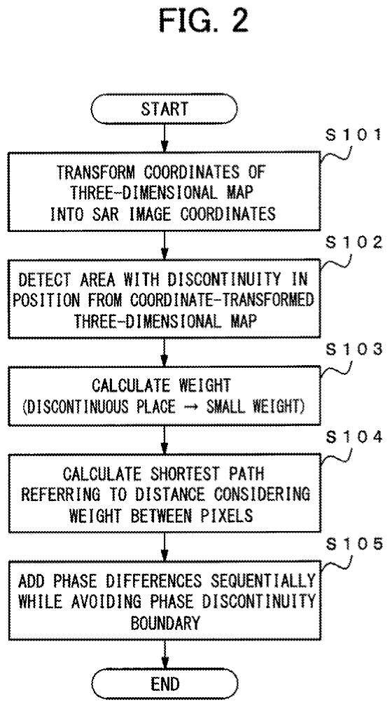

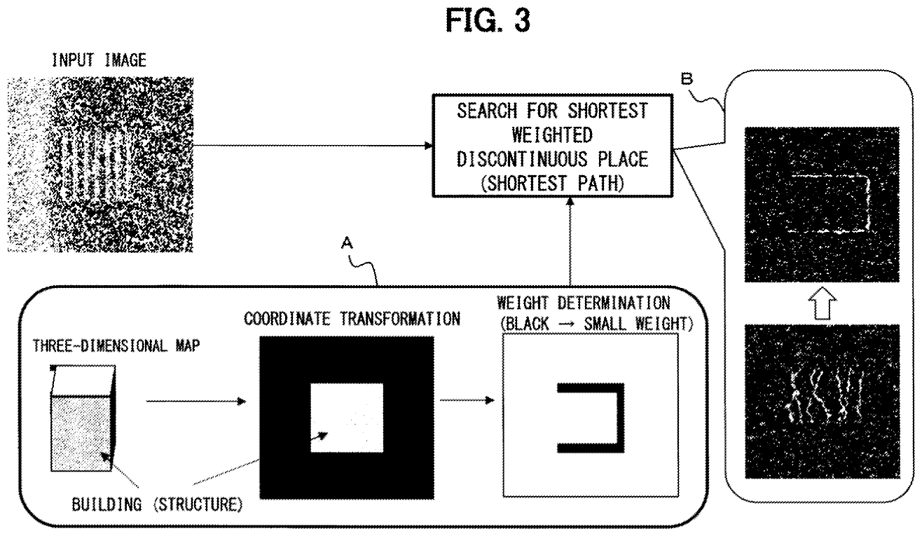

Next, the operation of the phase unwrapping device 1 will be described with reference to a flowchart of FIG. 2 and the explanatory diagram of FIG. 3. FIG. 2 is a flowchart showing the operation of the phase unwrapping device 1. FIG. 3 is an explanatory diagram showing operations of a coordinate transformation unit 102, a weight determination unit 103, and a discontinuous place calculation unit 104.

The coordinate transformation unit 102 extracts a map area corresponding to the photographed area of the SAR image from the three-dimensional maps stored in the three-dimensional map storage unit 101, and transforms the coordinates of the map area into the SAR image coordinates (step S101).

The weight determination unit 103 detects an area where the phase discontinuity is likely to occur in the phase difference image from the data of the map area whose coordinates are transformed to the SAR image coordinates. For example, the weight determination unit 103 extracts an area with a discontinuity in position (for example, a place where the coordinates in the height direction change significantly) as an area where a phase discontinuity is likely to occur (step S102).

In the example shown in FIG. 3, it is illustrated that when data of a structure such as a building exists in a three-dimensional map (refer to the frame A in FIG. 3), the discontinuous place calculation unit 104 extracts the outline place of the structure.

Then, the weight determination unit 103 assigns a smaller weight to a pixel or between pixels in the extracted area than to an area that is not extracted (step S103). In the example shown in FIG. 3, it is illustrated that the weight determination unit 103 assigns a small weight to the outline place of the structure (refer to the frame A in FIG. 3). The small weight means a relatively small weight. As an example, the weight determination unit 103 assigns 1 to the places where it is determined that the phase discontinuity does not occur and assigns 0 to the places where it is determined that the phase discontinuity can occur.

The discontinuous place calculation unit 104 uses the method described above, i.e., the shortest path connecting the edges that can be regarded as edges of the area where the phase difference is large, as the discontinuous boundary (step S104). In this example embodiment, when determining the shortest path, the discontinuous place calculation unit 104 refers to a weight between pixels or a distance between pixels to which weights are added as a product or sum. Thus, the shortest path is a path where the weights on the path are minimized, or a sum of distances between pixels evaluated by weight is minimized. When a distance between pixels to which small weight is assigned is referred to, it is more likely that the distance between the pixels is included in the shortest path. In other words, when a small weight is assigned to the pixel or to the distance between the pixels, there is a high possibility that the area where phase discontinuity is likely to occur will be included in the shortest path. Note that the weights are calculated by the weight determination unit 103.

The frame B in FIG. 3 shows an example of a situation in which the shortest path is determined for an input image (a phase difference image). An example of the case where the discontinuous place calculation unit 104 does not refer to the weighted distance between pixels is shown in the bottom row, and an example of the case where the discontinuous place calculation unit 104 refers to the weighted distance between pixels is shown in the bottom row. That is to say, when the discontinuous place calculation unit 104 refers to the weighted distance between pixels, the outline of the structure as an area where the phase discontinuity is likely to occur is included in the shortest path.

The outline of a structure is an example of an area in which a phase discontinuity is likely to occur. An area in which a phase discontinuity is likely to occur determined based on a three-dimensional image is not limited to the outline of a structure.

The unwrapping process unit 105 executes the phase unwrapping by the method described above. That is, the unwrapping process unit 105 sequentially adds the phase differences along an integration path that avoids discontinuous boundaries (step S105). In the configuration example shown in FIG. 1, the unwrapping process unit 105 stores the phase difference image after the phase unwrapping in the unwrapping result storage unit 106.

In this example embodiment, the weight determination unit 103 estimates in advance a place where the discontinuous phase is likely to occur. Then, the weight determination unit 103 assigns a small weight to the place where the discontinuous phase is likely to occur, so that the place is easily included in the shortest path (discontinuous boundary). By taking the assigned weights into account when the discontinuous place calculation unit 104 determines the shortest path, the discontinuous boundary can be estimated more accurately than when simply calculating the shortest path. As a result, the occurrence of unwrapping errors is suppressed.

In this example embodiment, phase unwrapping that integrates the phase (sequential adds phases) while avoiding a discontinuous boundary is used, however, it is available to apply the concept of this example embodiment to phase unwrapping using a method other than the method of sequentially adding phases, on condition that the method uses the discontinuous boundary during the phase unwrapping process.

### Example Embodiment 2

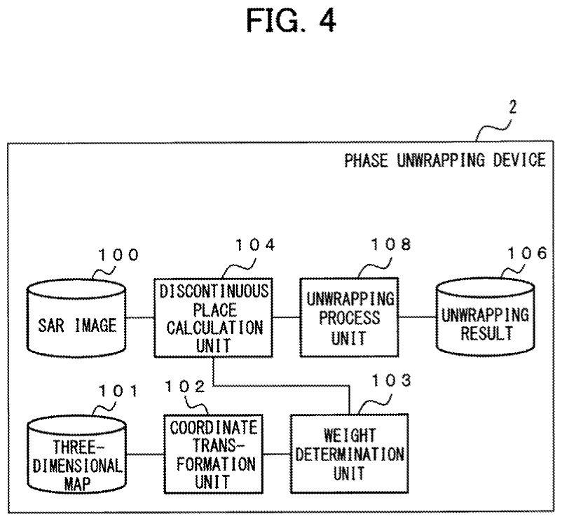

FIG. 4 is a block diagram showing a configuration example of a phase unwrapping device of the second example embodiment. The phase unwrapping device 1 shown in FIG. 4 includes the SAR image storage unit 100, the three-dimensional map storage unit 101, the coordinate transformation unit 102, the weight determination unit 103, the discontinuous place calculation unit 104, an unwrapping process unit 108, and the unwrapping result storage unit 106.

The unwrapping process unit 108 in this example embodiment performs phase unwrapping in a method different from the method performed by the unwrapping process unit 105 in the first example embodiment. The operation of the other components is the same as in the first example embodiment.

It is known that the phase after the ideal phase unwrapping is the same as the phase before phase unwrapping or shifted by an integer multiple of 2π from the phase before phase unwrapping in a phase difference image. To express it more precisely, the value of the phase difference between neighboring pixels before phase unwrapping is the same as the difference before phase unwrapping or shifted by an integer multiple of 2π from the difference before phase unwrapping. It is also known that the assumption that in many cases there are few areas where the shift of an integer multiple of 2π occurs.

Therefore, by minimizing a total value of differences between a phase before phase unwrapping and a phase after phase unwrapping (a difference between a value of a phase difference before phase unwrapping and a value of a phase difference after phase unwrapping), a phase unwrapping result with a reduced effect of noise can be obtained. The total value of the differences may be, for example, a total value of the single power of absolute values of the differences, or a total value of the other power of absolute values of the differences. It may also be a total value of other absolute value of the differences multiplied by a monotonically increasing function.

The unwrapping process unit 108 uses such a phase unwrapping method (hereinafter, referred to as the second method). When the second method is used, the unwrapping process unit 108 can use the processing result of the discontinuous place calculation unit 104.

As an example, when executing phase unwrapping, the unwrapping process unit 108 sets a weights of the pixel in the place where the discontinuous place calculation unit 104 determines to be a discontinuity boundary to 0 or a value close to 0, and multiplies the phase difference between the pixels by the weight. Furthermore, since a small weight is assigned to the pixel in the area where the weight determination unit 103 determines that a phase discontinuity is likely to occur, the unwrapping process unit 108 also uses the weight assigned by the weight determination unit 103. In other words, the unwrapping process unit 108 multiplies the pixel that is likely to occur a phase discontinuity by the weight assigned by the weight determination unit 103. Thereafter, the unwrapping process unit 108 executes phase unwrapping using the second method.

In this example embodiment, when phase unwrapping is executed using the second method, since the pixels that are likely to occur phase discontinuities are excluded (when the weight is 0), or the influence of the pixels that are likely to occur phase discontinuities is reduced when phase unwrapping is executed, the occurrence of unwrapping errors is suppressed in the same way as in the first example embodiment.

In each of the above example embodiments, a DSM is stored in the three-dimensional map storage unit 101 as a three-dimensional map, but the usable three-dimensional map is not limited to the DSM. For example, a two-dimensional map to which height information is attached for each geographical feature may be stored in the three-dimensional map storage unit 101 as a three-dimensional map. In that case, the coordinate transformation unit 102 transforms the coordinates of the two-dimensional map to which height information is attached for each geographical feature into the SAR image coordinates. In addition, a two-dimensional map having height information for each pixel may be used as a three-dimensional map stored in the three-dimensional map storage unit 101. In that case, the coordinate transformation unit 102 transforms the coordinates of the two-dimensional map having height information for each pixel into the SAR image coordinates.

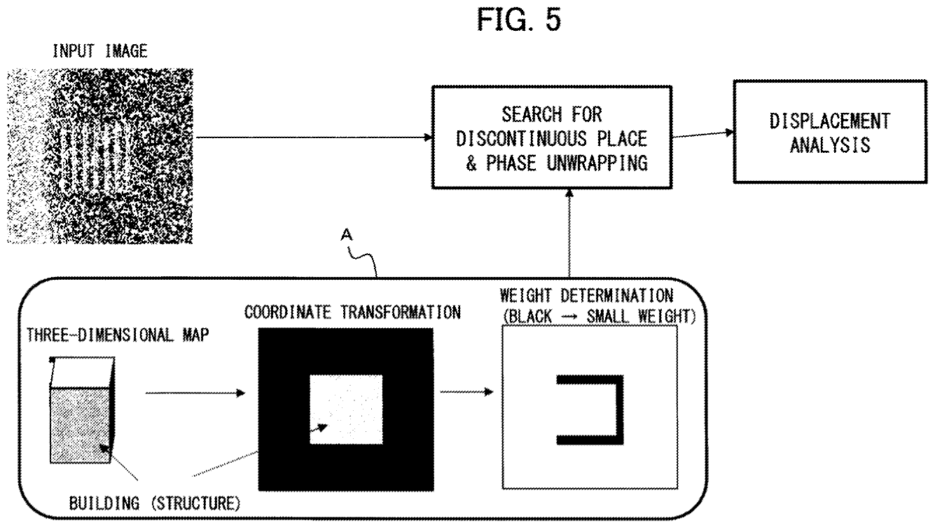

FIG. 5 is an explanatory diagram showing an application example of each of the above example embodiments. FIG. 5 shows an example in which the phase unwrapping device and the phase unwrapping method of the first example embodiment or the second example embodiment are applied to the displacement analysis using two or more (for example, two) SAR images photographed at different times. In the present invention, since phase unwrapping is executed taking into account structures and the like in a three-dimensional map, displacement analysis in an urban area or an urban location can be accurately performed.

Each component in each of the above example embodiments may be configured with a single piece of hardware, but can also be configured with a single piece of software. Alternatively, the components may be configured with a plurality of pieces of hardware or a plurality of pieces of software. Further, part of the components may be configured with hardware and the other part with software.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

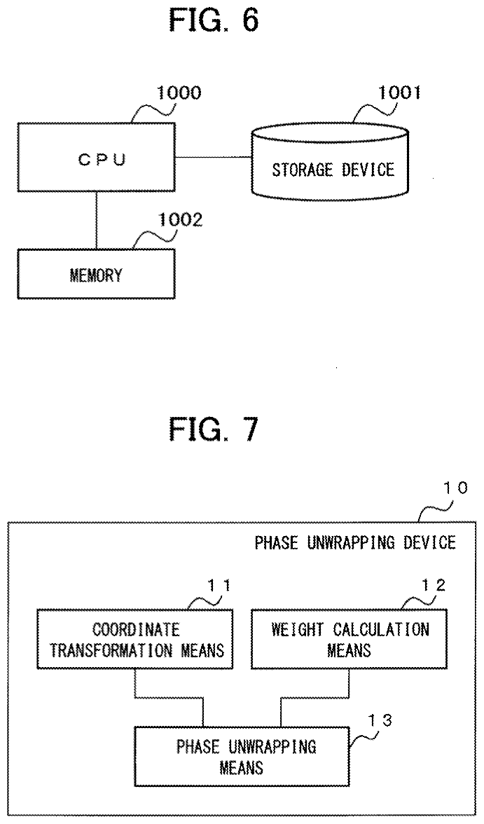

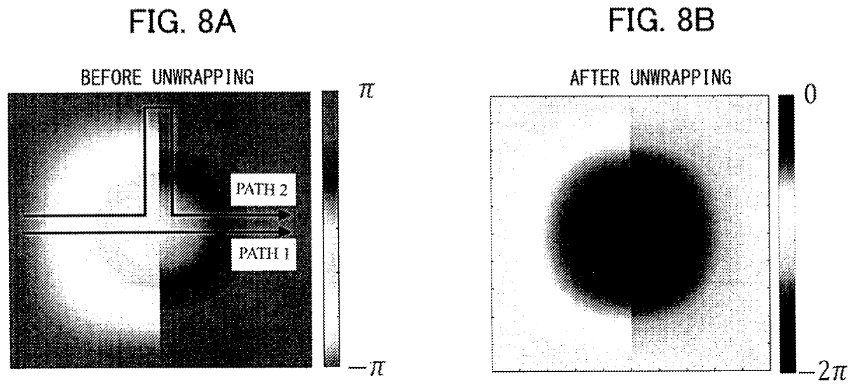

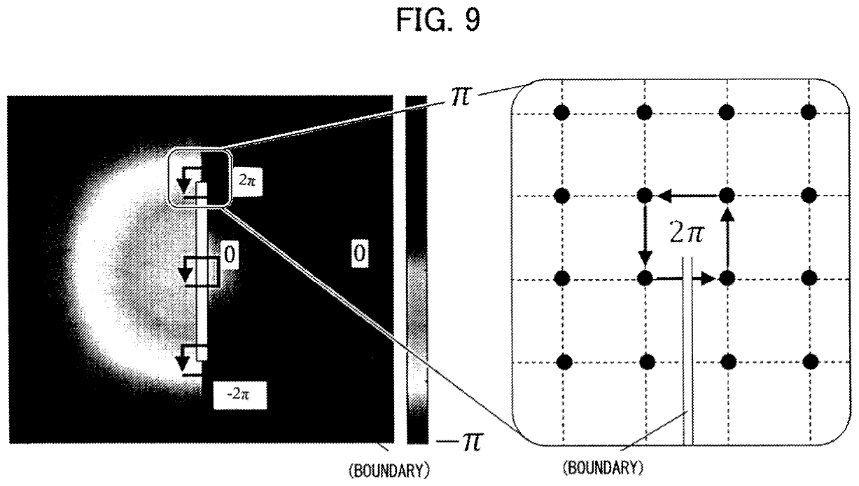

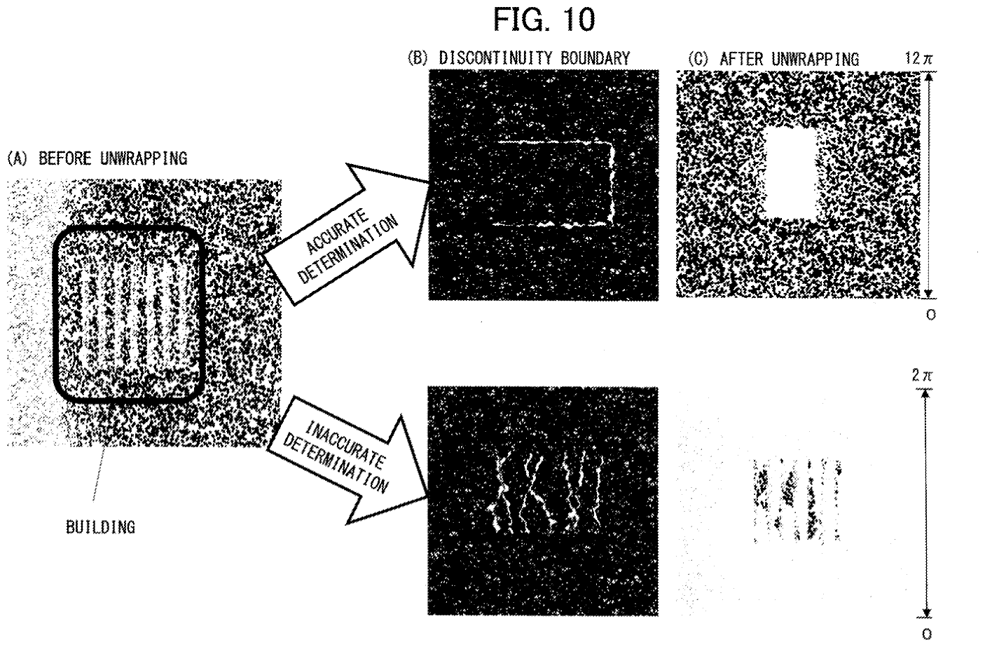

FIG. 6 is a block diagram showing an example of computer with a CPU. The computer is implemented in a phase unwrapping device. The CPU 1000 executes processing in accordance with a program stored in a storage device 1001 to realize the functions in the above example embodiments. That is, the computer realizes the functions of the three-dimensional map storage unit 101, the coordinate transformation unit 102, the weight determination unit 103, the discontinuous place calculation unit 104, and the unwrapping process units 105, 108 in the phase unwrapping devices 1, 2 shown in FIGS. 1 and 4.

The storage device 1001 is, for example, a non-transitory computer readable media. The non-transitory computer readable medium is one of various types of tangible storage media. Specific examples of the non-transitory computer readable media include a magnetic storage medium (for example, flexible disk, magnetic tape, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

FIG. 7 is a block diagram showing the main part of the phase unwrapping device. The phase unwrapping device 10 shown in FIG. 7 comprises coordinate transformation means 11 (in the example embodiments, realized by the coordinate transformation unit 102) for transforming coordinates of a map including height information into SAR image coordinates, weight calculation means 12 (in the example embodiments, realized by the weight determination unit 103) for determining a place, from the map whose coordinates are transformed into the SAR image coordinate, where phase discontinuity may occur in a phase different image generated from two SAR images and attaching a weight to the place where it is determined that phase discontinuity may occur, and phase unwrapping means 13 (in the example embodiments, realized by the discontinuous place calculation unit 104 and the unwrapping process unit 105, 108) for performing phase unwrapping for the phase difference image using the weight.

A part of or all of the above example embodiments may also be described as, but not limited to, the following supplementary notes.

(Supplementary note 1) A phase unwrapping device comprising:
coordinate transformation means for transforming coordinates of a map including height information into SAR image coordinates,
weight calculation means for determining a place, from the map whose coordinates are transformed into the SAR image coordinate, where phase discontinuity may occur in a phase different image generated from two SAR images and attaching a weight to the place where it is determined that phase discontinuity may occur, and
phase unwrapping means for performing phase unwrapping for the phase difference image using the weight.

(Supplementary note 2) The phase unwrapping device according to Supplementary note 1, wherein
the phase unwrapping means includes discontinuous place calculation means for calculating a phase discontinuous boundary in the phase difference image using the weight, and unwrapping process means for integrating the phase while avoiding the phase discontinuous boundary.

(Supplementary note 3) The phase unwrapping device according to Supplementary note 2, wherein
the weight calculating means attaches a relatively small weight to between pixels in the place where it is determined that phase discontinuity may occur, and
the discontinuous place calculation means calculates the shortest path between both ends of an area where the phase difference is greater than a predetermined value, taking into account the weight between pixels, and regards the calculated shortest path as the phase discontinuous boundary.

(Supplementary note 4) The phase unwrapping device according to Supplementary note 1, wherein
the phase unwrapping means performs the phase unwrapping by minimizing a difference between a phase before the phase unwrapping and the phase after the phase unwrapping.

(Supplementary note 5) The phase unwrapping device according to any one of Supplementary notes 1 to 4, further comprising three-dimensional map storage means for storing a DSM,
wherein the coordinate transformation means transforms the coordinates of the DSM into the SAR image coordinates.

(Supplementary note 6) The phase unwrapping device according to any one of Supplementary notes 1 to 4, further comprising three-dimensional map storage means for storing a two-dimensional map to which height information is attached for each geographical feature, wherein the coordinate transformation means transforms the coordinates of the two-dimensional map into the SAR image coordinates.

(Supplementary note 7) The phase unwrapping device according to any one of Supplementary notes 1 to 4, further comprising three-dimensional map storage means for storing a two-dimensional map with height information for each pixel,
wherein the coordinate transformation means transforms the coordinates of the two-dimensional map into the SAR image coordinates.

(Supplementary note 8) A phase unwrapping method comprising:
transforming coordinates of a map including height information into SAR image coordinates,
determining a place, from the map whose coordinates are transformed into the SAR image coordinate, where phase discontinuity may occur in a phase different image generated from two SAR images and attaching a weight to the place where it is determined that phase discontinuity may occur, and
performing phase unwrapping for the phase difference image using the weight.

(Supplementary note 9) The phase unwrapping method according to Supplementary note 8, wherein
a phase discontinuous boundary in the phase difference image is calculated using the weight, and the phase is integrated while avoiding the phase discontinuous boundary.

(Supplementary note 10) The phase unwrapping method according to Supplementary note 9, wherein
a relatively small weight is attached to between pixels in the place where it is determined that phase discontinuity may occur, and
the shortest path between both ends of an area where the phase difference is greater than a predetermined value is calculated, taking into account the weight between pixels, and the calculated shortest path is regarded as the phase discontinuous boundary.

(Supplementary note 11) The phase unwrapping method according to Supplementary note 8, wherein
the phase unwrapping is performed by minimizing a difference between a phase before the phase unwrapping and the phase after the phase unwrapping.

(Supplementary note 12) A phase unwrapping program causing a computer to execute:
a process of transforming coordinates of a map including height information into SAR image coordinates,
a process of determining a place, from the map whose coordinates are transformed into the SAR image coordinate, where phase discontinuity may occur in a phase different image generated from two SAR images and attaching a weight to the place where it is determined that phase discontinuity may occur, and
a process of performing phase unwrapping for the phase difference image using the weight.

(Supplementary note 13) The phase unwrapping program according to Supplementary note 12, causing the computer to execute
calculating a phase discontinuous boundary in the phase difference image using the weight, and integrating the phase while avoiding the phase discontinuous boundary.

(Supplementary note 14) The phase unwrapping program according to Supplementary note 13, causing the computer to execute
a process of attaching a relatively small weight to between pixels in the place where it is determined that phase discontinuity may occur, and
a process of calculating the shortest path between both ends of an area where the phase difference is greater than a predetermined value, taking into account the weight between pixels, and regarding the calculated shortest path as the phase discontinuous boundary.

(Supplementary note 15) The phase unwrapping program according to Supplementary note 12, causing the computer to execute
performing the phase unwrapping by minimizing a difference between a phase before the phase unwrapping and the phase after the phase unwrapping.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

1, 2, 10 Phase unwrapping device
11 Coordinate transformation means
12 Weight calculation means
13 Phase unwrapping means
100 SAR image storage unit
101 Three-dimensional map storage unit
102 Coordinate transformation unit
103 Weight determination unit
104 Discontinuous place calculation unit
105, 108 Unwrapping process unit
106 Unwrapping result storage unit
1000 CPU
1001 Storage device
1002 Memory

What is claimed is:

1. A phase unwrapping device comprising:
a coordinate transformation unit which transforms coordinates of a map including height information into SAR image coordinates,
a weight calculation unit which determines a place, from the map whose coordinates are transformed into the SAR image coordinate, where phase discontinuity may occur in a phase different image generated from two SAR images and attaches a weight to the place where it is determined that phase discontinuity may occur, and
a phase unwrapping unit which performs phase unwrapping for the phase difference image using the weight.

2. The phase unwrapping device according to claim 1, wherein
the phase unwrapping unit includes a discontinuous place calculation unit which calculates a phase discontinuous boundary in the phase difference image using the weight, and an unwrapping process unit which integrates the phase while avoiding the phase discontinuous boundary.

3. The phase unwrapping device according to claim 2, wherein
the weight calculating unit attaches a relatively small weight to between pixels in the place where it is determined that phase discontinuity may occur, and
the discontinuous place calculation unit calculates the shortest path between both ends of an area where the phase difference is greater than a predetermined value, taking into account the weight between pixels, and regards the calculated shortest path as the phase discontinuous boundary.

4. The phase unwrapping device according to claim 1, wherein
the phase unwrapping unit performs the phase unwrapping by minimizing a difference between a phase before the phase unwrapping and the phase after the phase unwrapping.

5. The phase unwrapping device according to claim 1, further comprising a three-dimensional map storage unit which stores a DSM,
wherein the coordinate transformation unit transforms the coordinates of the DSM into the SAR image coordinates.

6. The phase unwrapping device according to claim 1, further comprising a three-dimensional map storage unit which stores a two-dimensional map to which height information is attached for each geographical feature,
wherein the coordinate transformation unit transforms the coordinates of the two-dimensional map into the SAR image coordinates.

7. The phase unwrapping device according to claim 1, further comprising a three-dimensional map storage unit which stores a two-dimensional map with height information for each pixel,
wherein the coordinate transformation unit transforms the coordinates of the two-dimensional map into the SAR image coordinates.

8. A phase unwrapping method comprising:
transforming coordinates of a map including height information into SAR image coordinates,
determining a place, from the map whose coordinates are transformed into the SAR image coordinate, where phase discontinuity may occur in a phase different image generated from two SAR images and attaching a weight to the place where it is determined that phase discontinuity may occur, and
performing phase unwrapping for the phase difference image using the weight.

9. The phase unwrapping method according to claim 8, wherein
a phase discontinuous boundary in the phase difference image is calculated using the weight, and the phase is integrated while avoiding the phase discontinuous boundary.

10. The phase unwrapping method according to claim 9, wherein
a relatively small weight is attached to between pixels in the place where it is determined that phase discontinuity may occur, and
the shortest path between both ends of an area where the phase difference is greater than a predetermined value is calculated, taking into account the weight between pixels, and the calculated shortest path is regarded as the phase discontinuous boundary.

11. The phase unwrapping method according to claim 8, wherein
the phase unwrapping is performed by minimizing a difference between a phase before the phase unwrapping and the phase after the phase unwrapping.

12. A non-transitory computer readable recording medium storing a phase unwrapping program which, when executed by a processor, performs:
transforming coordinates of a map including height information into SAR image coordinates,
determining a place, from the map whose coordinates are transformed into the SAR image coordinate, where phase discontinuity may occur in a phase different image generated from two SAR images and attaching a weight to the place where it is determined that phase discontinuity may occur, and
performing phase unwrapping for the phase difference image using the weight.

13. The computer readable recording medium according to claim 12, wherein when executed by the processor, the program further performs
calculating a phase discontinuous boundary in the phase difference image using the weight, and integrating the phase while avoiding the phase discontinuous boundary.

14. The computer readable recording medium according to claim 13, wherein when executed by the processor, the program further performs
attaching a relatively small weight to between pixels in the place where it is determined that phase discontinuity may occur, and
calculating the shortest path between both ends of an area where the phase difference is greater than a predetermined value, taking into account the weight between pixels, and regarding the calculated shortest path as the phase discontinuous boundary.

15. The computer readable recording medium according to claim 12, wherein when executed by the processor, the program further performs
performing the phase unwrapping by minimizing a difference between a phase before the phase unwrapping and the phase after the phase unwrapping.
